(19) United States
(12) Patent Application Publication
(10) Pub. No.: US 2008/0152987 A1
(43) Pub. Date: Jun. 26, 2008

(54) Fuel cell system and vehicle with fuel cell system mounted thereon

(75) Inventors: Tomoaki Nakashima, Toyota-shi (JP); Haruyuki Nakanishi, Susono-shi (JP); Shinichi Matsumoto, Fuji-shi (JP)

Correspondence Address: KENYON & KENYON LLP, 1500 K STREET N.W., SUITE 700, WASHINGTON, DC, 20005, US

(73) Assignee: TOYOTA JIDOSHA KABUSHIKI KAISHA, Toyota-shi (JP)

(21) Appl. No.: 10/809,511

(22) Filed: Mar. 26, 2004

(30) Foreign Application Priority Data
May 19, 2003 (JP) 2003-140986
Nov. 18, 2003 (JP) 2003-387814

(51) Int. Cl. H01M 8/04

(52) U.S. Cl. 429/34; 429/38; 429/22

(57) ABSTRACT

A fuel cell system of the invention includes a tubular switching member 70 with slits 70a to shift their position and thereby vary an opening area of outlets of oxidizing gas conduits 36 in respective unit fuel cells 30 constituting a fuel cell stack 20. The system further includes a drive roller 74 and a stepping motor 79 that function to change over the position of the slits 70a. An electronic control unit controls rotation of the stepping motor 79 to actuate the tubular switching member 70 first to narrow the opening area of the outlets of the oxidizing gas conduits 36 to or toward 0 and then to widen the opening area of the outlets of the oxidizing gas conduits 36, thereby generating pulsation in the oxidizing gas conduits 36. Water droplets flocculated in the oxidizing gas conduits 36 are thus discharged to the outlets with high efficiency. The structure of the embodiment does not require any bypass in the respective unit fuel cells 30. The characteristic structure of the invention uses the frame of the unit fuel cell 30 equivalent to the existing one and does not substantially increase the size of the fuel cell stack 20.

### BACKGROUND OF THE INVENTION

1. Field of the Invention

The present invention relates to a fuel cell system and a vehicle with the fuel cell system. More specifically, the invention relates to a fuel cell system including a fuel cell that generates electric power through electrochemical reaction of oxygen included in an oxidizing gas, which is flown through an oxidizing gas conduit provided on a cathode side, and hydrogen included in a gaseous fuel, which is flown through a fuel gas conduit provided on an anode side, and a vehicle with the fuel cell system mounted thereon.

2. Description of the Prior Art

A known fuel cell system includes: fuel cells that generate electric power through electrochemical reaction of oxygen included in an oxidizing gas, which is flown through an oxidizing gas conduit provided on a cathode side of each electrolyte membrane with hydrogen included in a fuel gas, which is flown through a fuel gas conduit provided on an anode side of the electrolyte membrane; bypass conduits that are arranged in parallel to the gas conduits in the respective fuel cells; and pressure on-off valves, each of which is disposed in the bypass conduit and has a valve disc pressurized in an ordinary state to a closed position by a spring (for example, see FIG. 1 of Patent Application Gazette No. 2002-151113). In, this prior art fuel cell system, when water droplets flocculated in the gas conduit interfere with the smooth gas flow in the gas conduit, a force due to a pressure difference between an inlet pressure and an outlet pressure of the gas conduit exceeds the spring force of the pressure on-off valve to open the pressure on-off valve. The gas is then flown from the inlet of the gas conduit through the bypass conduit to the outlet of the gas conduit. This gradually reduces the pressure difference between the inlet pressure and the outlet pressure and eventually closes the pressure on-off valve. Repetition of the valve-opening and closing motions discharges the water droplets flocculated in the gas conduit.

This prior art structure requires the bypass conduit in addition to the gas conduit in each fuel cell and thus undesirably expands the size of the fuel cells in the fuel cell system. In this fuel cell system, when water droplets flocculated in the gas conduit interfere with the smooth gas flow in the gas conduit, the pressure on-off valve opens to make the gas flow through the bypass conduit. The pressure on-off valve shuts in response to a drop of the inlet pressure. The heightened inlet pressure is simply lowered by the gas flow through the bypass conduit. This arrangement does not effectively lead the water droplets flocculated in the gas conduit to its outlet.

### SUMMARY OF THE INVENTION

By taking into account the drawbacks of the prior art technique discussed above, the object of the invention is to provide a fuel cell system that discharges water droplets flocculated in gas conduits without increasing the size of the fuel cell system. The object of the invention is also to provide a fuel cell system that discharges water droplets flocculated in gas conduits efficiently. The object of the invention is further to provide a vehicle with such a fuel cell system mounted thereon.

A first fuel cell system of the present invention is a system that includes: a fuel cell that generates electric power through electrochemical reaction of oxygen included in an oxidizing gas, which is flown through an oxidizing gas conduit provided on a cathode side, and hydrogen included in a gaseous fuel, which is flown through a fuel gas conduit provided on an anode side; a switching member that opens and closes an outlet of at least one of the oxidizing gas conduit and the fuel gas conduit; and an actuation module that actuates said switching member to open and close the outlet of the at least one gas conduit.

In the fuel cell system of the invention, the actuation module actuates the switching member to open and close the outlet of the gas conduit. This arrangement controls the inner pressure of the gas conduit in good response and ensures efficient discharge of water droplet flocculated in the gas conduit to the outlet. The structure of this embodiment does not require any bypass, unlike the structure of cited Patent Document 1. The characteristic structure of the invention uses the frame of the fuel cell equivalent to the existing one and does not substantially increase the size of the fuel cell system.

In one preferable embodiment of the invention, the fuel cell system includes: a fuel cell stack that is a laminate of a number of fuel cells; and a gas exhaust manifold that connects with the outlet of the at least one gas conduit included in each of the fuel cells, and the switching member is located in said gas exhaust manifold. This arrangement ensures efficient elimination of water droplets flocculated in the gas conduits of the respective fuel cells constituting the fuel cell stack. The switching member is located in the existing gas exhaust manifold and accordingly does not expand the size of the fuel cell. The gas exhaust manifold may be an oxidizing gas exhaust manifold that connects with outlets of respective oxidizing gas conduits included in the fuel cells, or a fuel gas exhaust manifold that connects with outlets of respective fuel gas conduits included in the fuel cells. In one application of this embodiment, said fuel cell stack may be divided into multiple fuel cell blocks, where each of the multiple fuel cell blocks includes multiple fuel cells, said oxidizing gas exhaust manifold may be provided in each of the multiple fuel cell blocks and connects with outlets of respective oxidizing gas conduits of the multiple fuel cells included in each fuel cell block, and said fuel gas exhaust manifold may be provided in each of the multiple fuel cell blocks and connects with outlets of respective fuel gas conduits of the multiple fuel cells included in each fuel cell block. The respective fuel cells laminated in the fuel cell stack often have different levels of water content. This application accordingly divides the fuel cell stack into multiple fuel cell blocks and allows for discharge of the water content in each of the multiple fuel cell blocks.

In one preferable application of the invention, said switching member in the fuel cell system has a slit, and positioning of a remaining area of said switching member other than the slit to face the outlet of the at least one gas conduit narrows an opening area of the outlet of the gas conduit to or toward zero, while positioning of the slit of said switching member to face the outlet of the at least one gas conduit widens the opening area of the outlet of the gas conduit. Pulsation is generated in the gas conduit by simply changing over the positional relation between the slit formed in the switching member and the outlet of the gas conduit. The characteristics of the invention are thus actualized by this relatively simple structure. As one modification of this application, the switching member may be a tubular switching member, which has the slit on a circumferential face thereof and is rotatably located in a gas exhaust manifold, which connects with the outlet of the at least one gas conduit. The positional relation between the slit of the switching member and the outlet of the gas conduit is changeable by a relatively simple action of rotating the tubular switching member.

In still another preferable embodiment of the invention, the fuel cell system further includes an actuation control module that controls said actuation module to actuate said switching member first to narrow an opening area of the outlet of the at least one gas conduit to or toward zero and then to widen the opening area of the outlet of the gas conduit, thus generating pulsation in the gas conduit. The procedure first narrows the opening area of the outlet of the gas conduit to or toward zero to heighten the inner pressure of the gas conduit, and subsequently widens the opening area. The pressurized gas is thus vigorously flown through the gas conduit. Such pulsation generated in the gas conduit efficiently presses out the water droplets flocculated in the gas conduit to the outlet.

In one preferable application of the fuel cell system of the invention having the actuation control module, the actuation control module controls the actuation module to generate the pulsation in the at least one gas conduit according to a state of water flocculation in the gas conduit. This arrangement ensures adequate elimination of water droplets flocculated in the gas conduit. The ‘state of water flocculation’ may be specified, in response to a detection signal of a sensor, which actually detects water droplets flocculated in the gas conduit. Another applicable procedure measures a physical quantity (for example, temperature, humidity, or output status) of the fuel cell under the condition of flocculation of water droplets in the gas conduit and determines the ‘state of water flocculation’, based on the observed physical quantity.

In another preferable application of the fuel cell system of the invention having the actuation control module, the actuation control module controls the actuation module to generate the pulsation in the at least one gas conduit, either when an output of the fuel cell exceeds a preset output level or when a measurement of integral power of the fuel cell exceeds a preset power level. This arrangement effectively generates pulsation in the gas conduit and thereby adequately eliminates water droplets flocculated in the gas conduit under the condition of the high output of the fuel cell or under the high integral power of the fuel cell, which often leads to flocculation of water droplets in the gas conduit. Here the ‘preset output level’ and the ‘preset power level’ may be set corresponding to the measurements of the output and the integral power of the fuel cell under the condition of flocculation of water droplets in the gas conduit. The actuation control module may control the actuation module to generate the pulsation in the at least one gas conduit when the output of the fuel cell exceeds the preset output level and when the measurement of integral power of the fuel cell exceeds the preset power level.

As one modification, the fuel cell system of the invention with the actuation control module may further include a storage module that stores an output behavior of the fuel cell under condition of flocculation of water droplets in the at least one gas conduit. The actuation control module controls the actuation module to generate the pulsation in the gas conduit, when an observed output behavior of the fuel cell in service substantially coincides with the output behavior stored in the storage module. This procedure compares the output behavior of the fuel cell under the condition of flocculation of water droplets in the gas conduit (for example, a time variation of output voltage) with the observed output behavior of the fuel cell in service and adequately determines the state of flocculation of water droplets in the gas conduit.

In still another preferable application of the fuel cell system of the invention having the actuation control module, the actuation control module controls the actuation module to generate the pulsation in the at least one gas conduit at regular intervals. Such relatively simple control effectively eliminates water droplets flocculated in the gas conduit. Here the ‘regular interval’ may be every preset time period to flocculation of water droplets in the gas conduit during the operation of the fuel cell, which is determined empirically.

A second fuel cell system of the present invention is a system that includes: a fuel cell that generates electric power through electrochemical reaction of oxygen included in an oxidizing gas, which is flown through an oxidizing gas conduit provided on a cathode side, and hydrogen included in a gaseous fuel, which is flown through a fuel gas conduit provided on an anode side; a fuel cell stack that is a laminate of a number of the fuel cells and is divided into multiple fuel cell blocks, where each fuel cell block including multiple fuel cells; oxidizing gas exhaust manifolds, each of which connects with outlets of respective oxidizing gas conduits of the multiple fuel cells included in each fuel cell block; fuel gas exhaust manifolds, each of which connects with outlets of respective fuel gas conduits of the multiple fuel cells included in each fuel cell block; regulation modules, each of which regulates an outlet opening area of at least one of said oxidizing gas exhaust manifold and said fuel gas exhaust manifold in each fuel cell block; and an actuation module that actuates said regulation modules.

This fuel cell system of the invention regulates the opening area of at least one of the oxidizing gas exhaust manifold and the fuel gas exhaust manifold in each of the multiple fuel cell blocks. The respective fuel cells laminated in the fuel cell stack often have different levels of water content. This application accordingly divides the fuel cell stack into multiple fuel cell blocks and allows for discharge of the water content in each of the multiple fuel cellblocks. The water droplets flocculated in the gas conduit are thus efficiently discharged to the outlet in each of the fuel cell blocks. The structure of this embodiment does not require any bypass, unlike the structure of cited Patent Document 1. The characteristic structure of the invention uses the frame of the fuel cell equivalent to the existing one and does not substantially increase the size of the fuel cell system.

In one embodiment of the invention, said fuel cell system further include: a parameter value measurement module that measures value of a parameter relating to a level of water content in each of the fuel cell blocks; a water level determination module that determines the level of water content in each of the fuel cell blocks, based on the value of the parameter measured by said parameter value measurement module; and an actuation control module that controls said actuation module to actuate said regulation module in a specific fuel cell block, which has an excess level of water content determined by said water level determination module, to increase the outlet opening area of said at least one gas exhaust manifold to be greater than a preset reference area. The procedure regulates the opening area of the gas exhaust manifold to be wider than the reference area in the fuel cell block in the flooding state. This ensures efficient elimination of the water content flocculated in the gas conduits of the respective fuel cells in the fuel cell block. In this embodiment, said parameter value measurement module may measure an internal resistance in each of the fuel cell blocks, and said water level determination module may determine that a specific fuel cell block has an excess level of water content, when the observed internal resistance of the specific fuel cell block is below a preset appropriate range.

In another preferable embodiment of the invention, the fuel cell system further include: a parameter value measurement module that measures value of a parameter relating to a level of water content in each of the fuel cell blocks; a water level determination module that determines the level of water content in each of the fuel cell blocks, based on the value of the parameter measured by said parameter value measurement module; and an actuation control module that controls said actuation module to actuate said regulation module in a specific fuel cell block, which has an insufficient level of water content determined by said water level determination module, to decrease the outlet opening area of said at least one gas exhaust manifold to be smaller than a preset reference area. The procedure regulates the opening area of the gas exhaust manifold to be narrower than the reference area in the fuel cell block in the dry-up state. This causes the water content to be retained in the gas conduits of the respective fuel cells included in the fuel cell block and thus desirably cancels the dry-up state. In this embodiment, said parameter value measurement module may measure an internal resistance in each of the fuel cell blocks, and said water level determination module may determine that a specific fuel cell block has an insufficient level of water content, when the observed internal resistance of the specific fuel cell block is over a preset appropriate range.

In one application of the above two embodiments, the fuel cell system further includes a block position recognition module that recognizes a positional relation of the multiple fuel cell blocks, and said actuation control module increases the preset reference area of said at least one gas exhaust manifold in a specific fuel cell block, which is recognized to be located downward by said block position recognition module. The fuel cell block located at the downward position among the fuel cell blocks included in the fuel cell stack tends to have a high level of the water content, because of the gravity. The reference area is thus widened to accelerate elimination of the water content in the fuel cell block located at the downward position.

The vehicle of the invention has the fuel cell system of any of the above arrangement mounted thereon. The fuel cell system of any arrangement discussed above generates pulsation and presses out the water droplets flocculated in the gas conduit to the outlet. The vehicle with this fuel cell system mounted thereon naturally exerts the equivalent functions and effects to those of the fuel cell systems discussed above.

### BRIEF DESCRIPTION OF THE DRAWINGS

FIG. 1 schematically illustrates the configuration of a vehicle with a fuel cell system mounted thereon in a first embodiment of the invention;

FIG. 2 is a decomposed perspective view of a unit fuel cell;

FIG. 3 is a perspective view schematically illustrating a tubular switching member;

FIG. 4 shows the positional relation between slits of the tubular switching member and oxidizing gas conduits;

FIG. 5 is sectional views of the unit fuel cell;

FIG. 6 is a flowchart showing an oxidizing gas conduit outlet switching routine;

FIGS. 7 and 8 are a perspective view schematically illustrating a switching member in one modified structure of the first embodiment;

FIG. 9 is a perspective view schematically illustrating a fuel cell stack in a second embodiment.;

FIG. 10 shows supply flows and exhaust flows of oxidizing gas and fuel gas in the second embodiment;

FIG. 11 is a block diagram of a back-pressure control valve in the second embodiment;

FIG. 12 shows a connection with the electronic control unit in the second embodiment;

FIG. 13 is a plot of internal resistance Ri against water content in each fuel cell block in the second embodiment;

FIG. 14 is a flowchart showing a water content adjustment routine in the second embodiment;

FIG. 15 is a flowchart showing a tilt response process routine in the second embodiment;

FIG. 16 is a plan view of a fuel cell stack in one modified structure of the second embodiment;

and FIG. 17 is a flowchart showing a water content adjustment routine in one modified structure of the second embodiment.

### DESCRIPTION OF THE PREFERRED EMBODIMENTS

### First Embodiment

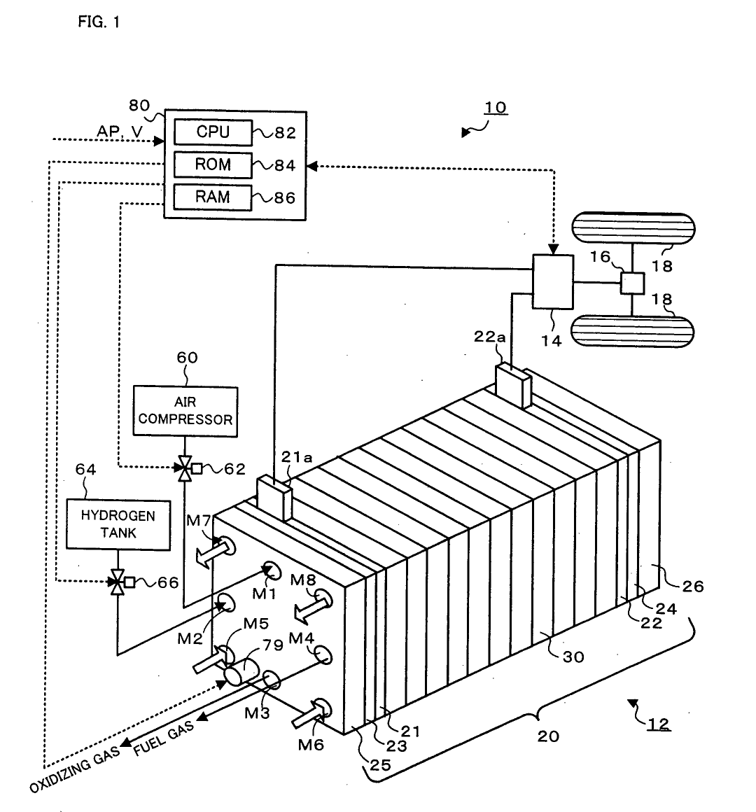

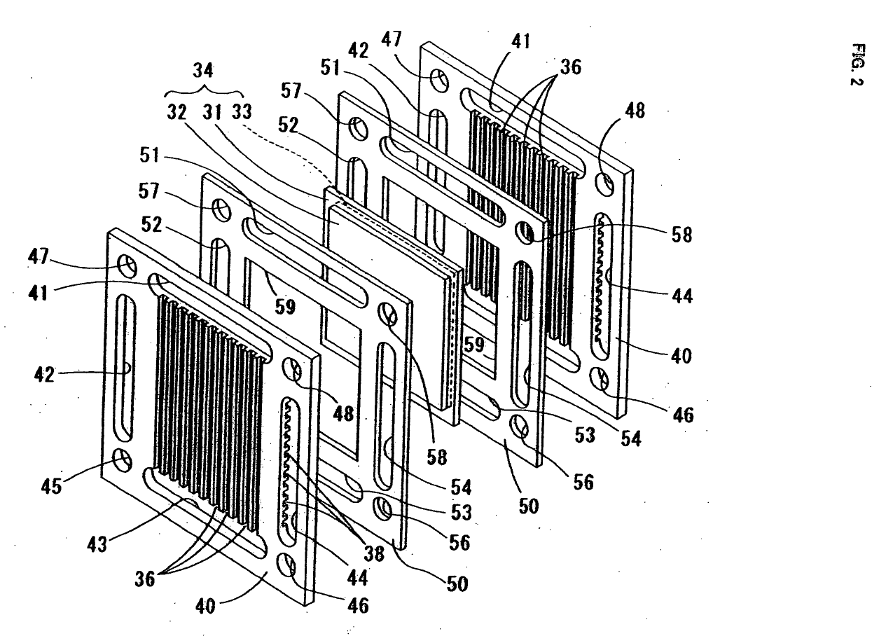

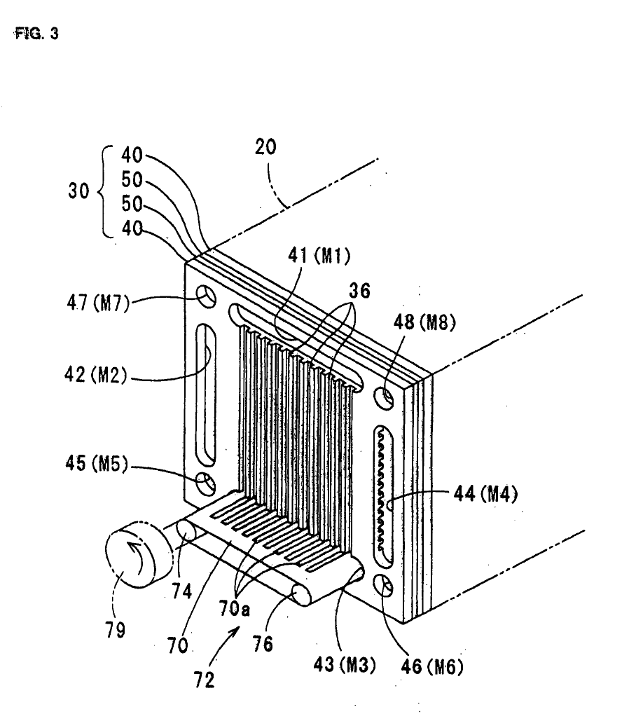

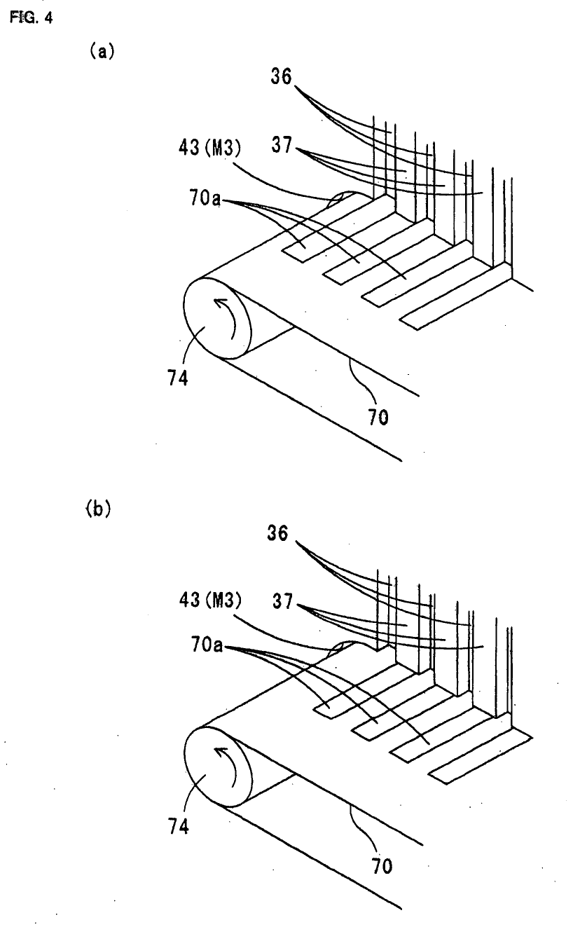

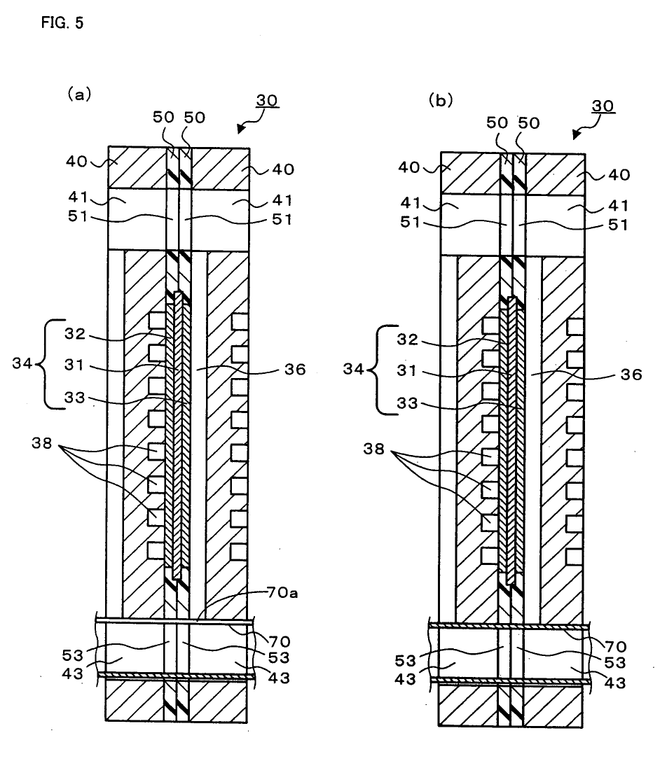

Some embodiments of the invention are discussed below with reference to the drawings. FIG. 1 schematically illustrates the configuration of a vehicle 10 with a fuel cell system 12 mounted thereon in a first embodiment of the invention. FIG. 2 is a decomposed perspective view of a unit fuel cell 30. FIG. 3 is a perspective view schematically illustrating a tubular switching member 70. FIG. 4 shows the positional relation between slits 70a of the tubular switching member 70 and oxidizing gas conduits 36. FIG. 5 is sectional views of the unit fuel cell 30.

As shown in FIG. 1, the vehicle 10 of this embodiment includes a fuel cell system 12, an actuation mechanism 14 that converts a supply of electric power from the fuel cell system 12 into driving force and rotates driving wheels 18, 18 via a reduction gear 16 with the driving force, and an electronic control unit 80 that controls the whole vehicle 10. The fuel cell system 12 has a fuel cell stack 20, which is a stack of multiple unit fuel cells 30 generating electric power through electrochemical reactions of hydrogen and oxygen, supply manifolds Ml and M2 to feed supplies of an oxidizing gas and a gaseous fuel to the respective unit fuel cells 30, and exhaust manifolds M3 and M4 to lead exhausts of the oxidizing gas and the gaseous fuel, which have passed through the respective unit fuel cells 30, out of the fuel cell stack 20. The vehicle 10 of this embodiment further includes a tubular switching member 70 (see FIG. 3) located in the oxidizing gas exhaust manifold M3 to open and close the outlets of the oxidizing gas conduits 36.

The fuel cell stack 20 is manufactured by stacking a plurality of the unit fuel cells 30 as base units and sequentially arranging a pair of collector plates 21 and 22, a pair of insulator plates 23 and 24, and a pair of end plates 25 and 26 on respective ends of the stack of the unit fuel cells 30. The collector plates 21 and 22 are composed of a gas-impermeable electric conductive material, such as dense carbon or copper. The insulator plates 23 and 24 are composed of an insulating material, such as rubber or resin. The end plates 25 and 26 are composed of a metal having rigidity, such as steel. The collector plates 21 and 22 respectively have output terminals 21a and 22a to output an electromotive force generated by the fuel cell stack 20. A holder mechanism (not shown) causes the end plates 25 and 26 to hold the respective unit cells 30 under pressure applied in its stacking direction.

As shown in FIGS. 2 and 5, each of the unit fuel cells 30 has a membrane electrode assembly (MEA) 34 including an anode 32 and a cathode 33 arranged across an electrolyte membrane 31, and a pair of separators 40, 40 disposed on both ends of the MEA 34. The electrolyte membrane 31 has good proton conductivity in its wet state. A Nafion membrane manufactured by DuPont is preferably applied for the electrolyte membrane 31. Each of the anode 32 and the cathode 33 has a catalyst electrode with platinum or an alloy of platinum and another metal carried thereon and a gas diffusion electrode of carbon cloth, which is a woven fabric of carbon fibers. The MEA 34 is obtained by integrating the anode 32, the electrolyte membrane 31, and the cathode 33 by thermo compression. Each of the separators 40 is composed of a gas-impermeable electric conductive material, for example, mold carbon obtained by compressing carbon to be gas impermeable. As shown in FIG. 2, an oxidizing gas supply port 41 and an oxidizing gas exhaust port 43 penetrating the separator 40 are formed on the approximate centers of an upper side and a lower side of the separator 40. A gaseous fuel supply port 42 and a gaseous fuel exhaust port 44 penetrating the separator 40 are also formed on the approximate centers of a left side and a right side of the separator 40. Circular apertures 45 through 48 penetrating the separator 40 for circulation of cooling water are also formed on four corners of the separator 40. Multiple grooves going from the oxidizing gas supply port 41 to the oxidizing gas exhaust port 43 form an oxidizing gas conduit 36 on one face of the separator 40. Similarly multiple grooves going from the gaseous fuel supply port 42 to the gaseous fuel exhaust port 44 form a gaseous fuel conduit 38 on the other face of the separator 40.

Gaskets 50 are interposed between the MEA 34 and the respective separators 40, as shown in FIG. 2. The gaskets 50 are arranged across the electrolyte membrane 31 to restrain leakage of the gaseous fuel and the oxidizing gas and to prevent the flow of the oxidizing gas from being mixed with the flow of the gaseous fuel in the space between the separators 40, 40. Each of the gaskets 50 has slots 51 through 54 perforated to face the oxidizing gas supply port 41, the gaseous fuel supply port 42, the oxidizing gas exhaust port 43, and the gaseous fuel exhaust port 44 of the separator 40 respectively, circular apertures 55 through 58 perforated to face the circular apertures 45 through 48 respectively (the circular aperture 55 is omitted from the illustration), and a square hole formed in a size to receive the anode 32 or the cathode 33 therein.

Among the supply manifolds, the oxidizing gas supply manifold M1 is a hollow space of connecting the oxidizing gas supply port 41 of the separator 40 with the slot 51 of the gasket 50 in the respective unit fuel cells 30 in the stacking direction of the fuel cell stack 20. A supply of the air as the oxidizing gas is fed from an air compressor 60 via a flow control valve 62, is humidified by a non-illustrated humidifier, and is flown into the oxidizing gas supply manifold M1. The gaseous fuel supply manifold M2 is a hollow space of connecting the gaseous fuel supply port 42 of the separator 40 with the slot 52 of the gasket 50 in the respective unit fuel cells 30 in the stacking direction of the fuel cell stack 20. A supply of gaseous hydrogen as the gaseous fuel is fed from a hydrogen tank 64 via a flow control valve 66, is humidified by a non-illustrated humidifier, and is flown into the gaseous fuel supply manifold M2. Cooling water inflow manifolds M5 and M6 are respectively hollow spaces of connecting the circular apertures 45 and 46 of the separator 40 with the circular apertures 55 and 56 of the gasket 50 in the respective unit fuel cells 30 in the stacking direction of the fuel cell stack 20. A flow of cooling water as the coolant is fed from a non-illustrated pump and is flown into the cooling water inflow manifolds M5 and M6.

Among the exhaust manifolds, the oxidizing gas exhaust manifold M3 is a hollow space of connecting the oxidizing gas exhaust port 43 of the separator 40 with the slot 53 of the gasket 50 in the respective unit fuel cells 30 in the stacking direction of the fuel cell stack 20. The exhaust of the oxidizing gas, which has passed through the oxidizing gas conduits 36 of the respective unit fuel cells 30, is collectively led out of the fuel cell stack 20. The gaseous fuel exhaust manifold M4 is a hollow space of connecting the gaseous fuel exhaust port 44 of the separator 40 with the slot 54 of the gasket 50 in the respective unit fuel cells 30 in the stacking direction of the fuel cell stack 20. The exhaust of the gaseous fuel, which has passed through the gaseous fuel conduits 38 of the respective unit fuel cells 30, is collectively led out of the fuel cell stack 20. The exhaust of the gaseous fuel still includes non-reacted hydrogen and may thus be re-circulated into the gaseous fuel supply manifold M2. Cooling water outflow manifolds M7 and M8 are respectively hollow spaces of connecting the circular apertures 47 and 48 of the separator 40 with the circular apertures 57 and 58 of the gasket 50 in the respective unit fuel cells 30 in the stacking direction of the fuel cell stack 20. The hot flow of cooling water, which has passed through cooling water conduits formed in cooling water separators (not shown) disposed at intervals of several unit fuel cells 30 in the fuel cell stack 20, is collectively led out of the fuel cell stack 20. The hot flow of cooling water is cooled down by means of a non-illustrated radiator and is re-circulated into the cooling water inflow manifolds M5 and M6.

As shown in FIGS. 3 and 4, the tubular switching member 70 is a belt member spanned in an elliptic tubular shape between a drive roller 74 and a driven roller 76 located on both ends in the oxidizing gas exhaust manifold M3. The tubular switching member 70 is a metal thin plate or a resin thin plate and has multiple slits 70a, 70a, . . . arranged to be locatable corresponding to the outlets of the respective oxidizing gas conduits 36. The drive roller 74 is actuated and rotated by a stepping motor 79, which functions as an operation module attached to the outer face of the end plate 25 of the fuel cell stack 20. Gear rings (not shown) are set on the drive roller 74 and the driven roller 76. With rotations of the respective rollers 74 and 76, the teeth of the gear rings sequentially engage with guide apertures (not shown) formed in the tubular switching member 70 and thereby move the tubular switching member 70 in its rotating direction. There is accordingly no slippage of the tubular switching member 70 against the respective rollers 74 and 76. The rotation of the tubular switching member 70 by the drive roller 74 stops the slits 70a, 70a, . . . at the positions facing the outlets of the oxidizing gas conduits 36 to open the outlets of the oxidizing gas conduits 36 (see FIGS. 4(a) and 5(a)). The rotation of the tubular switching member 70 by the drive roller 74 alternatively stops the slits 70a, 70a, . . . at the positions facing the projections 37, which part the adjacent oxidizing gas conduits 36, 36, to close the outlets of the oxidizing gas conduits 36 (see FIGS. 4(b) and 5(b)). The inner space encircled by the tubular switching member 70 has substantially the same size as that of the oxidizing gas exhaust manifold M3.

The actuation mechanism 14 (see FIG. 1) has a power converter to convert the d.c. power generated by the fuel cell stack 20 into a.c. power and a traction motor driven and rotated with the converted a.c. power, although not being specifically illustrated.

Referring back to FIG. 1, the electronic control unit 80 is constructed as a microprocessor including a CPU 82, a ROM 84 that stores processing programs, a RAM 86 that temporarily stores data, and an input-output port (not shown). The electronic control unit 80 receives, as inputs via the input port, an accelerator pedal opening signal AP sent from an accelerator pedal sensor (not shown), a vehicle speed signal V sent from a vehicle speed sensor (not shown), and an input-output voltage signal of the power converter included in the actuation mechanism 14. The electronic control unit 80 outputs control signals to the flow control valve 62 for regulating the flow of the air and to the flow control valve 66 for regulating the flow of hydrogen, as well as control signals to the stepping motor 79 and to the power converter and the traction motor included in the actuation mechanism 14 via its output port.

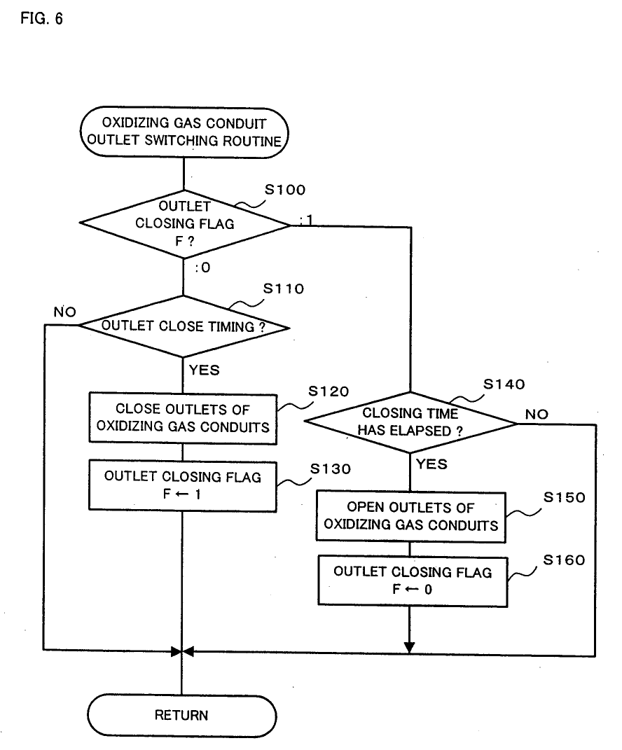

The following describes the operations of the vehicle 10 of the embodiment constructed as discussed above, especially an operation of removing water droplets flocculated in the oxidizing gas conduits 36 during a run of the vehicle 10. In the initial state, the slits 70a of the tubular switching member 70 are arranged at the positions to open the outlets of the oxidizing gas conduits 36, that is, at the positions facing the outlets of the oxidizing gas conduits 36 (see FIGS. 4(a) and 5(a)). FIG. 6 is a flowchart showing an oxidizing gas conduit outlet switching routine, which is executed by the CPU 82 of the electronic control unit 80. This routine is stored in the ROM 84 and is repeatedly executed by the CPU 82 at preset time intervals (for example, at every several msec). When this routine starts, the CPU 82 first determines whether an outlet closing flag F is equal to 0 or 1 (step S100). The outlet closing flag F is set to 1 in the closed position of the tubular switching member 70 to close the outlets of the oxidizing gas conduits 36, and is reset to 0 in the open position of the tubular switching member 70 to open the outlets of the oxidizing gas conduits 36. The outlet closing flag F is reset to 0 in the initial settings. When it is determined at step S100 that the outlet closing flag F is equal to 0, the CPU 82 subsequently determines whether the current time is an outlet close timing (step S110). Here, the outlet close timing comes whenever a fixed time period elapses. The fixed time period is determined by actually measuring a time to flocculation of water droplets in the oxidizing gas conduits 36 in the operating state of the fuel cell stack 20. When the current time is not the outlet close timing, this routine is terminated immediately. When the current time is the outlet close timing, on the other hand, the CPU 82 controls the rotation of the stepping motor 79 and makes the drive roller 74 rotate the tubular switching member 70 to stop the slits 70a at the positions facing the projections 37, which part the adjacent oxidizing gas conduits 36, 36, that is, to close the outlets of the oxidizing gas conduits 36 with the remaining areas other than the slits 70a (see FIGS. 4(a) and 5(a)) (step S120). The CPU 82 then sets the outlet closing flag F to 1 (step S130) and exits from this routine.

When it is determined at step S100 that the outlet closing flag F is equal to 1, the outlets of the oxidizing gas conduits 36 have already been closed to heighten the inner pressure of the oxidizing gas conduits 36. In this case, the CPU 82 subsequently determines whether a preset closing time has elapsed since the previous setting of the outlet closing flag F to 1 (step S140). When the preset closing time has not yet elapsed, the routine is terminated immediately. When the preset closing time has elapsed, on the other hand, it is assumed that the inner pressure of the oxidizing gas conduits 36 has been heightened to a specified level. The CPU 82 accordingly controls the rotation of the stepping motor 70 and makes the drive roller 74 rotate the tubular switching member 70 to stop the slits 70a at the positions facing the outlets of the oxidizing gas conduits 36, that is, to open the outlets of the oxidizing gas conduits 36 (see FIGS. 4(b) and 5(b)) (step S150). The CPU 82 then resets the outlet closing flag F to 0 (step S160) and exits from this routine. The closing time is set to be shorter than the interval of the outlet close timings.

The control of this embodiment closes the outlets of the oxidizing gas conduits 36 of the unit fuel cells 30 to heighten the inner pressure of the oxidizing gas conduits 36 and then opens the outlets of the oxidizing gas conduits 36. The pressurized oxidizing gas accordingly gushes through and out of the oxidizing gas conduits 36. Generation of such pulsation in the oxidizing gas conduits 36 efficiently discharges water droplets flocculated in the oxidizing gas conduits 36 to the oxidizing gas exhaust manifold M3. The tubular switching member 70 is adopted to open and close the outlets of the oxidizing gas conduits 36. This arrangement ensures regulation of the inner pressure of the oxidizing gas conduits 36 in good response. The structure of this embodiment does not require any bypass in the unit fuel cells 30, unlike the structure of cited Patent Document 1. In the structure of the embodiment, the tubular switching member 70 and the rollers 74 and 76 are located in the existing oxidizing gas exhaust manifold M3. This characteristic structure of the embodiment uses the frame of the unit fuel cell 30 equivalent to the existing one and does not substantially increase the size of the fuel cell stack 20. Pulsation is generated in the oxidizing gas conduits 36 by simply changing over the positional relation between the slits 70a of the tubular switching member 70 and the outlets of the oxidizing gas conduits 36. The characteristics of the invention are thus actualized by this relatively simple structure. The positional relation between the slits 70a of the tubular switching member 70 and the outlets of the oxidizing gas conduits 36 is changeable by a relatively simple action of rotating the tubular switching member 70. The relatively simple control of the embodiment generates pulsation in the oxidizing gas conduits 36 at regular intervals and thereby effectively removes water droplets flocculated in the oxidizing gas conduits 36.

Some examples of possible modification of the first embodiment are given below. The procedure of the first embodiment generates pulsation in the oxidizing gas conduits 36 at every outlet close timing, that is, whenever the fixed time period elapses. One possible modification measures the humidity under the condition of flocculation of water droplets in the oxidizing gas conduits 36 and sets the observed humidity to a threshold value T0. A humidity sensor is located in the oxidizing gas conduits 36. The procedure of this modification determines that the outlet close timing comes when the humidity measured by the humidity sensor reaches or exceeds the threshold value T0, and generates pulsation in the oxidizing gas conduits 36. This arrangement generates pulsation in the oxidizing gas conduits 36 according to the status of flocculation of water droplets, thus effectively removing the water droplets flocculated in the oxidizing gas conduits 36.

Another possible modification determines that the outlet close timing comes when a high power output is required to the fuel cell stack 20 and generates pulsation in the oxidizing gas conduits 36. Requirement of the high power output to the fuel cell stack 20 depends upon determination of whether an electric power demand to the fuel cell stack 20 reaches or exceeds a preset threshold value T1. The electric power demand to the fuel cell stack 20 is calculated from a vehicle power demand to the drive wheels 18, 18. The vehicle power demand is specified corresponding to current inputs of a vehicle speed signal V and an accelerator pedal opening signal AP by referring to a non-illustrated map stored in the ROM 84. The threshold value T1 is empirically set in advance. The higher output of the fuel cell stack 20 causes the more vigorous electrochemical reaction to produce a large amount of water. The large amount of water is readily flocculated in the oxidizing gas conduits 36 to interfere with the smooth flow of the oxidizing gas. The procedure of this modification experimentally determines the relation between the amount of flocculated water in the oxidizing gas conduits 36 and the output power of the fuel cell stack 20 and sets the output power of the fuel cell stack 20 at the time when the amount of flocculated water possibly interferes with the smooth flow of the oxidizing gas, to the threshold value T1.

Still another possible modification determines that the outlet close timing comes when a measurement of integral power of the fuel cell stack 20 reaches or exceeds a specific level under the requirement of a high power output to the fuel cell stack 20. When the measurement of integral power has not reached the specific level under the requirement of the high power output to the fuel cell stack 20, the electrochemical reaction becomes vigorous only temporarily and does not cause flocculation of water droplets in the oxidizing gas conduits 36. The requirement of the high power output to the fuel cell stack 20 may, however, continue for a relatively long time period. In this case, the measurement of integral power reaches the specific level, while the electric power demand continuously exceeds the threshold value T1. This state often leads to flocculation of water droplets in the oxidizing gas conduits 36. This specific level of the integral power is thus determined experimentally and is set to a threshold value T2. The procedure of this modification determines that the outlet close timing comes when the measurement of integral power reaches or exceeds the threshold value T2, while the electric power demand to the fuel cell stack 20 continuously exceeds the threshold value T1.

Another possible modification stores a time-varying behavior of output voltage of the fuel cell stack 20 under the condition of flocculation of water droplets in the oxidizing gas conduits 36, in the ROM 84. The procedure of this modification determines that the outlet close timing comes when the observed time-varying behavior of output voltage of the fuel cell stack 20 in service substantially coincides with the time-varying behavior stored in the ROM 84, and generates pulsation in the oxidizing gas conduits 36. This arrangement ensures adequate judgment of flocculation of water droplets in the oxidizing gas conduits 36.

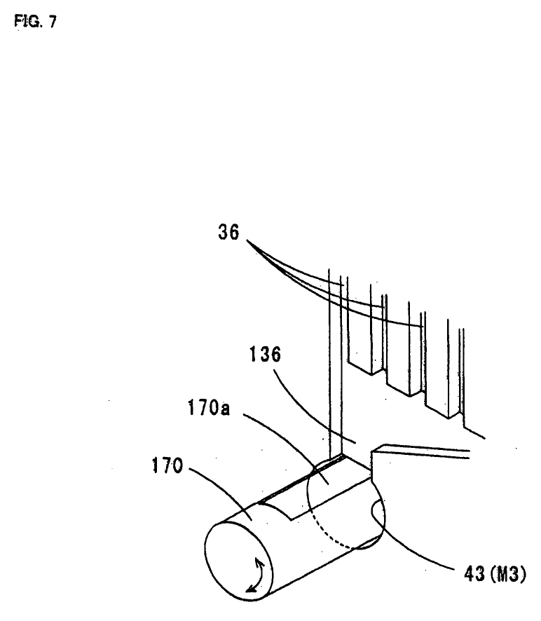

The structure of the first embodiment adopts the tubular switching member 70 having the elliptic cross section. In one modified structure of the unit fuel cell 30 shown in FIG. 7, the outlets of the multiple oxidizing gas conduits 36 are joined together to one collecting conduit 136, which is connected to the oxidizing gas exhaust manifold M3. In this case, a tubular switching member having a quasi circular cross section and a slit on its circumferential face, for example, a rotary valve 170 with a slit 170a, is adopted to open and close the outlet of the collecting conduit 136. The rotary valve 170 is arranged in an axially rotatable manner in the oxidizing gas exhaust manifold M3. The stepping motor 79 switches over the positional relation between the slit 170a of the rotary valve 170 and the outlet of the collecting conduit 136 to open and close the outlet of the collecting conduit 136.

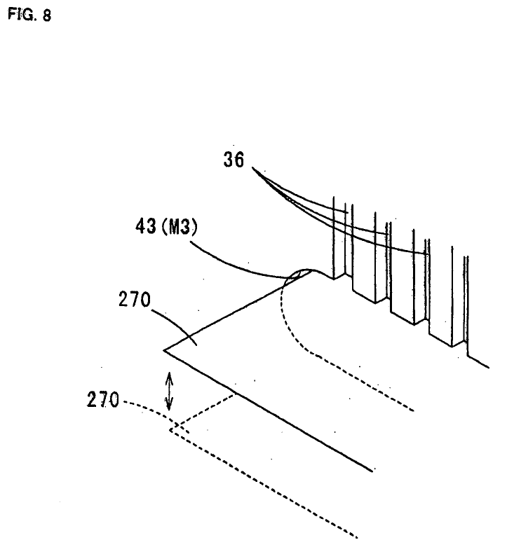

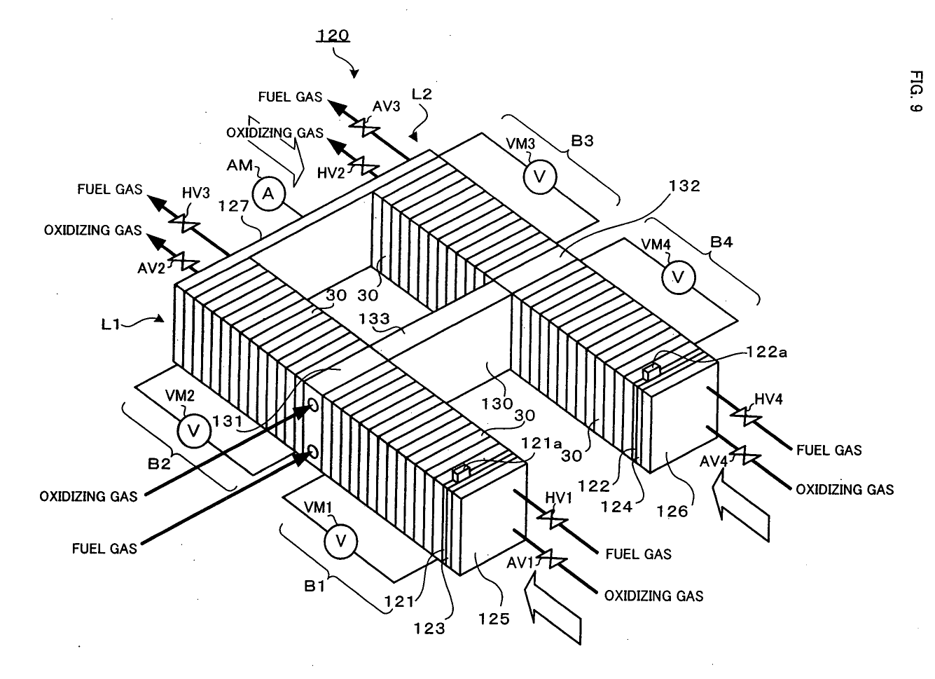

The control of the first embodiment regulates the positional relation between the slits 70a of the tubular switching member 70, which is spanned between the drive roller 74 and the driven roller 76, and the outlets of the oxidizing gas conduits 36 to open and close the outlets of the oxidizing gas conduits 36. In another modified structure shown in FIG. 8, a metal or resin thin plate 270 with no slits is located in the oxidizing gas exhaust manifold M3 and is moved up and down by means of a non-illustrated actuator (for example, a motor or a solenoid) to close the outlets of the oxidizing gas conduits 36 (the state shown by the solid line in FIG. 8) and open the outlets of the oxidizing gas conduits 36 (the state shown by the dotted line in FIG. 8).

The control of the above embodiment either perfectly matches the slits 70a of the tubular switching member 70 with the outlets of the oxidizing gas conduits 36 to open the outlets or perfectly matches the remaining areas of the tubular switching member 70 other than the slits 70a with the outlets of the oxidizing gas conduits 36 to close the outlets. One possible modification may regulate the rotation of the stepping motor 79 to vary an overlap area (opening area) of the outlets of the oxidizing gas conduits 36 with the slits 70a. This modified arrangement ensures sensitive regulation of the pulsating pressure in the oxidizing gas conduits 36.

In the structure of the embodiment discussed above, the oxidizing gas conduits 36 are formed as linear grooves going from the oxidizing gas supply port 41 to the oxidizing gas exhaust port 43. The oxidizing gas conduits 36 may be formed as curved grooves or a serpentine groove. Another possible structure may mount small cubes or small rectangular parallelepipeds at preset intervals on the surface of the separator 40 and set the gaps defined by the cubes or rectangular parallelepipeds as the oxidizing gas conduits 36.

The control of the first embodiment opens and closes the outlets of the oxidizing gas conduits 36 to generate pulsation in the oxidizing gas conduits 36. In addition to or instead of this operation, the control may open and close the outlets of the fuel gas conduits 38 in a similar manner to generate pulsation in the fuel gas conduits 38. The supply of fuel gas fed to the fuel gas conduits 38 is humidified, and excess humidification may flocculate water droplets in the fuel gas conduits 38.

In the embodiment discussed above, the fuel cell system 12 is mounted on the vehicle 10. The fuel cell system 12 may be mounted on any other vehicles and transportation machines like trains and aircraft, and may be incorporated in any cogeneration systems installed for domestic applications and industrial applications. In any case, the fuel cell system 12 and its applications exert the equivalent functions and effects to those discussed above.

### Second Embodiment

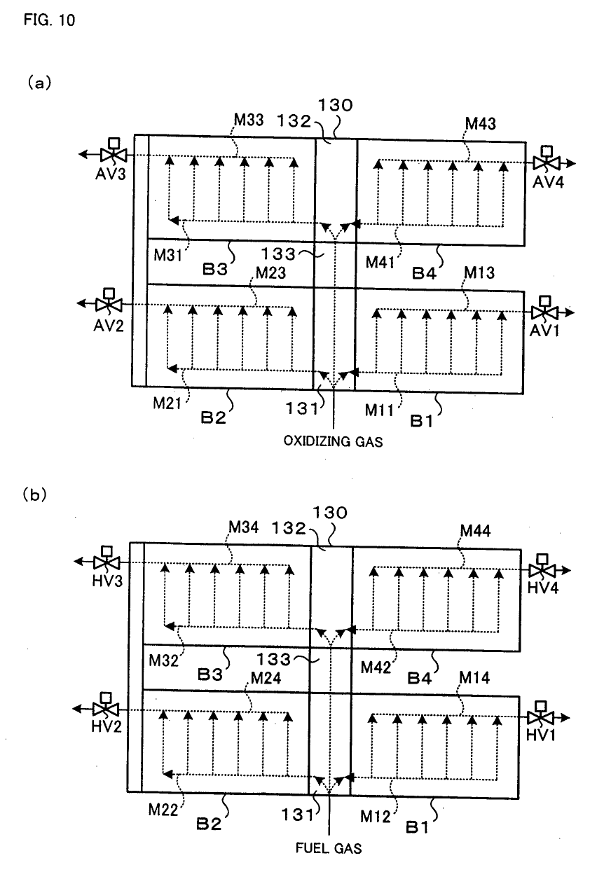

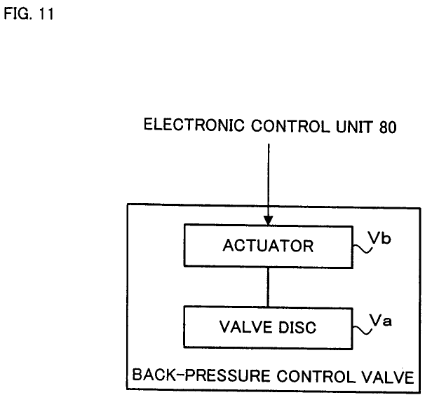

A second embodiment replaces the fuel cell stack 20 of the first embodiment with a fuel cell stack 120 and otherwise has the same structure as that of the first embodiment. The like constituents have the like numerals and symbols and are not specifically described here. FIG. 9 is a perspective view schematically illustrating a fuel cell stack 120 in the second embodiment. FIG. 10 shows supply flows and exhaust flows of oxidizing gas and fuel gas in the second embodiment. FIG. 11 is a block diagram of a back-pressure control valve in connection with the electronic control unit 80 in the second embodiment.

As shown in FIG. 9, the fuel cell stack 120 of the second embodiment has several hundred unit fuel cells 30 (identical with that of the first embodiment) as base units, which are arranged in two lines, a first line L1 and a second line L2. The two lines L1 and L2 are mutually connected in a U shape via a joint plate 127. The joint plate 127 is composed of a gas-impermeable and electrically-conductive material, such as dense carbon or copper. The joint plate 127 connects the several hundred unit fuel cells 30 in series. The fuel cell stack 120 includes four fuel cell blocks, that is, first through fourth fuel cell blocks B1 through B4. Each of the fuel cell blocks B1 through B4 has one quarter of the several hundred unit fuel cells 30. The first fuel cell block B1 and the second fuel cell block B2 constitute the first line L1, whereas the third fuel cell block B3 and the fourth fuel cell block B4 constitute the second line L2. A manifold formation plate 130 is interposed between the first fuel cell block B1 and the second fuel cell block B2 and between the third fuel cell block B3 and the fourth fuel cell block B4.

In each of the first fuel cell block B1 and the fourth fuel cell block B4, a stack of multiple unit fuel cells 30 is arranged between the manifold formation plate 130 and a collector plate 121 or 122. An insulator plate 123 or 124 and an end plate 125 or 126 are further located outside the collector plate 121 or 122. The collector plates 121 and 122 respectively have terminals 121a and 122a. The manifold formation plate 130 has an electrically conductive first insertion section 131 interposed between the first fuel cell block B1 and the second fuel cell block B2, an electrically conductive second insertion section 132 interposed between the third fuel cell block B3 and the fourth fuel cell block B4, and a coupling section 133 that connects the first insertion section 131 with the second insertion section 132 in a dielectric manner. The first insertion section 131 and the second insertion section 132 are composed of a gas-impermeable and electrically-conductive material, such as dense carbon or copper. The coupling section 133 is composed of an insulating material, such as rubber or resin. In each of the second fuel cell block B2 and the third fuel cell block B3, a stack of multiple unit fuel cells 30 is arranged between the manifold formation plate 130 and the joint plate 127. The end plates 125 and 126 and the joint plate 127 are pressurized by a non-illustrated pressure unit respectively in the directions of open arrows shown in FIG. 9. This structure causes the unit fuel cells 30 to be held in close contact with one another in the fuel cell stack 120. An ammeter AM is attached to the fuel cell stack 120. First through fourth voltmeters VM1 through VM4 are respectively attached to first through fourth fuel cell blocks B1 through B4.

As shown in FIG. 10(a), the first insertion section 131 of the manifold formation plate 130 is constructed to distribute the flow of oxidizing gas into a first oxidizing gas supply manifold M11 and a second oxidizing gas supply manifold M21 of the first and the second fuel cell blocks B1 and B2. The second insertion section 132 of the manifold formation plate 130 is constructed to distribute the flow of oxidizing gas into a third oxidizing gas supply manifold M31 and a fourth oxidizing gas supply manifold M41 of the third and the fourth fuel cell blocks B3 and B4. As shown in FIG. 10(b), the first insertion section 131 of the manifold formation plate 130 is constructed to distribute the flow of fuel gas into a first fuel gas supply manifold M12 and a second fuel gas supply manifold M22 of the first and the second fuel cell blocks B1 and B2. The second insertion section 132 of the manifold formation plate 130 is constructed to distribute the flow of fuel gas into a third fuel gas supply manifold M32 and a fourth fuel gas supply manifold M42 of the third and the fourth fuel cell blocks B3 and B4. The flow of oxidizing gas and the flow of fuel gas distributed to the respective unit fuel cells 30 pass through the corresponding gas conduits formed inside the respective unit fuel cells 30 and are discharged via first through fourth oxidizing gas exhaust manifolds M13, M23, M33, and M43 and first through fourth fuel gas exhaust manifolds M14, M24, M34, and M44 of the first through the fourth fuel cell blocks B1 through B4. First through fourth oxidizing gas back-pressure control valves (first through fourth air back-pressure control valves) AV1 through AV4 as solenoid valves are disposed in route of discharge of the oxidizing gas from the first through the fourth oxidizing gas exhaust manifolds M13, M23, M33, and M43. First through fourth fuel gas back-pressure control valves (first through fourth hydrogen back-pressure control valves) HV1 through HV4 as solenoid valves are disposed en route of discharge of the fuel gas from the first through the fourth fuel gas exhaust manifolds M14, M24, M34, and M44. Each of the back-pressure control valves AV1 through AV4 and HV1 through HV4 has a valve disc Va (corresponding to the regulation module of the invention) to regulate the gas permeation area (opening area) and an actuator Vb (corresponding to the actuation module of the invention) to actuate the valve disc Va in response to a control signal from the electronic control unit 80, as shown in FIG. 11.

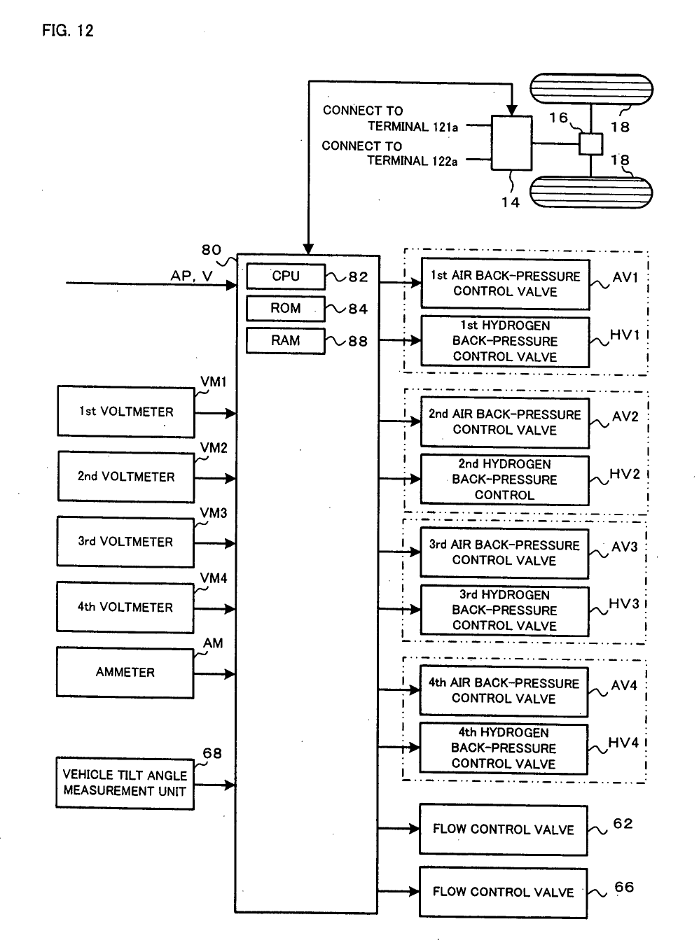

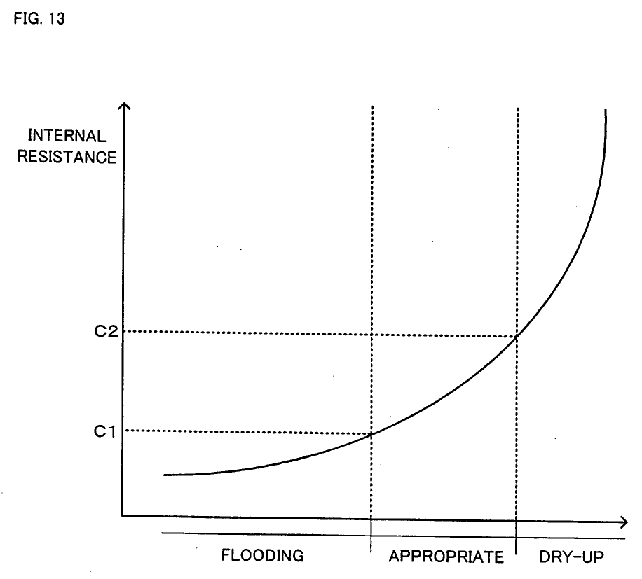

The electronic control unit 80 includes the CPU 82, the ROM 84, and the RAM 86, like the first embodiment. The electronic control unit 80 receives, via its input port (not shown), detection signals from the first through the fourth voltmeters VM1 through VM4, from the ammeter AM, and from a vehicle tilt angle measurement unit 68 to measure the tilt angle of the vehicle, as well as the accelerator pedal opening signal AP, the vehicle speed signal V, and the electric signals from the power converter included in the actuation mechanism 14, as shown in FIG. 12. In the structure of the second embodiment, the vehicle tilt angle measurement unit 68 measures the tilt of the vehicle, which stops on an inclined road surface. The vehicle tilt angle measurement unit 68 may otherwise detect a change in attitude of the vehicle, based on suspension strokes of the respective wheels or based on the acceleration of the vehicle. The electronic control unit 80 outputs, via its output port (not shown), control signals to the first through the fourth air back-pressure control valves AV1 through AV4 and to the first through the fourth hydrogen back-pressure control valves HV1 through HV4, as well as control signals to the flow control valve 62 to regulate the flow of the air, to the flow control valve 66 to regulate the flow of hydrogen, and to the power converter and the traction motor included in the actuation mechanism 14. A plot of internal resistance Ri against water content in each fuel cell block is stored in the form of a map shown in FIG. 13 in the ROM 84 of the electronic control unit 80. The plot of FIG. 13 is determined in advance experimentally or empirically. In the map of this embodiment, each fuel cell block has an appropriate level of water content when the internal resistance Ri satisfies C1≦Ri≦C2, an excess level of water content (flooding) when the internal resistance Ri satisfies Ri<C1, and an insufficient level of water content (dry-up) when the internal resistance Ri satisfies C2<Ri. Here C1 and C2 denote values set in advance experimentally or empirically.

The following describes the operations of the vehicle of the second embodiment constructed as discussed above. As shown in FIG. 12, the CPU 82 of the electronic control unit 80 receives current inputs of the accelerator pedal opening signal AP and the vehicle speed signal V and specifies a power demand P in response to these input signals. The CPU 82 specifies an air flow and a hydrogen flow to be fed to the fuel cell stack 120, so as to ensure an electric power output from the fuel cell stack 120 that meets the power demand P and regulates the flow control valves 62 and 66 according to the specified air flow and hydrogen flow. The vehicle accordingly runs with the electric power output from the fuel cell stack 120 to meet the driver's demand.

The control of this embodiment keeps the water content in the fuel cell stack 120 at an appropriate level during a run of the vehicle. In the initial state, the first through the fourth air back-pressure control valves AV1 through AV4 and the first through the fourth hydrogen back-pressure control valves HV1 through HV4 are set at respective reference positions, which are in the middle of full-open positions and full-closed positions. The initial state also resets the values of process counters and timers built in the electronic control unit 80 to 0, while resetting the values of dry-up flags FD1 through FD4 and flooding flags FF1 through FF4 of the respective fuel cell blocks B1 through B4 to 0. Each of the dry-up flags FD is set to 1 in execution of a process of eliminating the dry-up state and is otherwise reset to 0. Each of the flooding flags FF is set to 1 in execution of a process of eliminating the flooding state and is otherwise reset to 0.

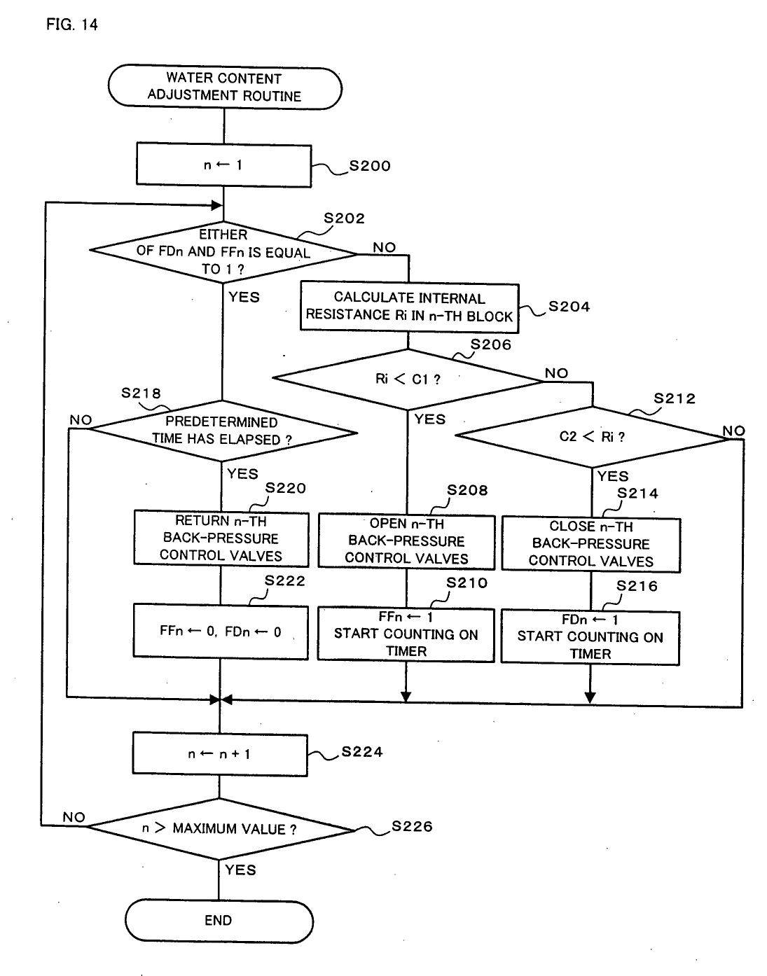

FIG. 14 is a flowchart showing a water content adjustment routine, which is executed by the CPU 82 of the electronic control unit 80. This routine is stored in the ROM 84 and is repeatedly executed by the CPU 82 at preset time intervals (for example, at every several msec). When this routine starts, the CPU 82 first sets a value ‘1’ to a process counter n (where n represents an integral number) (step S200) and determines whether either of a dry-up flag FDn and a flooding flag FFn is equal to 1 (step S202). When neither of the flags FDn and FFn is equal to 1, that is, both of the flags FDn and FFn are equal to 0, the CPU 82 calculates an internal resistance Ri of an n-th fuel cell block from inputs of electric current measured by the ammeter AM and voltage measured by an n-th voltmeter VMn (step S204) and determines whether the calculated internal resistance Ri satisfies Ri<C1 (step S206). When Ri<C1 is satisfied, it is determined that the n-th fuel cell block is in the flooding state according to the map of FIG. 13. The CPU 82 accordingly regulates an n-th air back-pressure control valve AVn and an n-th hydrogen back-pressure control valve HVn from their reference positions in the respective opening directions to increase the flows of the air and hydrogen into the n-th fuel cell block (step S208). The CPU 82 then sets the flooding flag FFn to 1, sets a predetermined time on the counter, and starts countdown (step S210). The excess water content in the n-th fuel cell block is thus effectively purged out with the gas flows. The back-pressure control valves AVn and HVn may be set in their full-open positions or in the halfway positions.

When Ri<C1 is not satisfied at step S206, that is, in the case of C1<Ri, on the other hand, the CPU 82 subsequently determines whether the calculated internal resistance Ri satisfies C2<Ri (step S212). When C2<Ri is satisfied, it is determined that the n-th fuel cell block is in the dry-up state according to the map of FIG. 13. The CPU 82 accordingly regulates the n-th air back-pressure control valve AVn and the n-th hydrogen back-pressure control valve HVn from their reference positions in the respective closing directions to retain the flows of the air and hydrogen in the n-th fuel cell block (step S214). The CPU 82 then sets the dry-up flag FDn to 1, sets a predetermined time on the counter, and starts countdown (step S216). The humidified gaseous hydrogen and the humidified air are thus retained in the n-th fuel cell block to raise the level of the water content. The back-pressure control valves AVn and HVn may be set in their full-closed positions or in the halfway positions.

When either of the dry-up flag FDn and the flooding flag FFn is equal to 1 at step S202, the timer continues counting down. It is then determined whether the count on the timer reaches 0, that is, whether the predetermined time has elapsed (step S218). When the predetermined time has elapsed, the CPU 220 returns the n-th air back-pressure control valve AVn and the n-th hydrogen back-pressure control valve HVn to their reference positions (step S220) and resets the dry-up flag FDn and the flooding flag FFn to 0 (step S222). The predetermined time with regard to the flooding state is specified empirically and represents a time period required for purging out the excess water content to the appropriate level since the opening action of the back-pressure control valves in the fuel cell block in the flooding state. The predetermined time with regard to the dry-up state is specified empirically and represents a time period required for raising the water content to the appropriate level since the closing action of the back-pressure control valves in the fuel cell block in the dry-up state. The predetermined time with regard to the flooding state may be identical with or different from the predetermined time with regard to the dry-up state.

When determining that the predetermined time has not yet elapsed at step S218, after resetting both the flags FDn and FFn to 0 at step S222, after starting the countdown on the timer at step S210 or at step S216, or when C2<Ri is not satisfied at step S212, that is, when the calculated internal resistance Ri of the n-th fuel cell block is in the appropriate range of C1≦Ri≦C2, the CPU 82 increments the value of the process counter n by one (step S224) and determines whether the incremented value of the process counter n exceeds its maximum value (4 in this embodiment) (step S226). When the value of the process counter n does not exceed the maximum value, the program returns to step S202 and executes the processing of and after step S202. When the value of the process counter n exceeds the maximum value, the program exits from this routine. The procedure calculates the internal resistance Ri in each of the fuel cell blocks B1 through B4 and regulates the back-pressure control valves in the opening direction or in the closing direction, based on the calculated internal resistance Ri, thus attaining the appropriate level of water content in each of the fuel cell blocks B1 through B4.

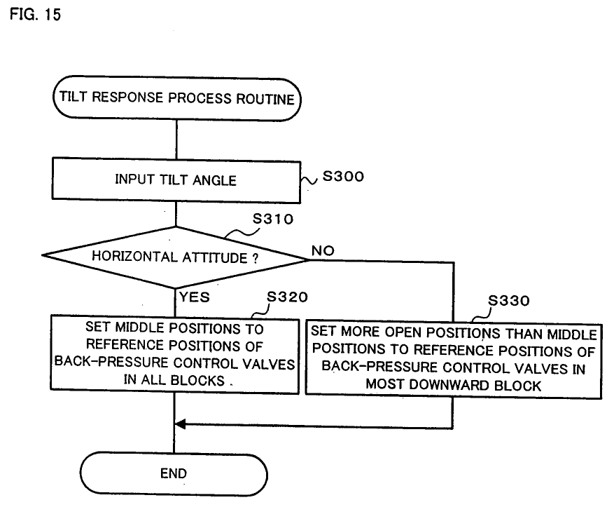

A tilt response process routine is executed as part of the processing to keep the water content in the fuel cell stack 120 at the appropriate level during a run of the vehicle. FIG. 15 is a flowchart showing this tilt response process routine. This routine is stored in the ROM 84 and is repeatedly executed by the CPU 82 at preset timings (for example, at every several msec). When this routine starts, the CPU 82 first receives an input of tilt angle measured by the vehicle tilt angle measurement unit 68 (step S300), and determines whether the vehicle has horizontal attitude based on the input tilt angle (step S310). When the vehicle has the horizontal attitude, the CPU 82 sets the middle positions between the full-open positions and the full-closed positions to the reference positions of the air back-pressure control valves AV1 through AV4 and the hydrogen back-pressure control valves HV1 through HV4 of all the fuel cell blocks B1 through B4 (step S320). This routine is then terminated. The reference positions in this state are identical with the reference positions in the initial state. When the vehicle does not have the horizontal attitude at step S310, on the other hand, the CPU 82 specifies a fuel cell block (or maybe multiple fuel cell blocks) located at the most downward position among the fuel cell blocks B1 through B4 constituting the fuel cell stack 120 and sets the more open positions than the middle positions to the reference positions of the air back-pressure control valve and the hydrogen back-pressure control valve of the specified fuel cell block (step S330). This routine is then terminated. The fuel cell block located at the most downward position in the fuel cell stack 120 tends to have a high level of the water content, because of the gravity. Setting the reference positions of the back-pressure control valves in the most downward fuel cell block to the more open positions than the middle positions increases the flows of the air and hydrogen. This operation desirably prevents the increase in water content. The positions of the back-pressure control valves regulated in the opening direction at step S208 should be in the more open positions than those at step S330.

The unit fuel cells 30 included in the fuel cell stack 120 often have different levels of the water content. The structure of the second embodiment thus divides the fuel cell stack 120 into the multiple fuel cell blocks B1 through B4 and controls to eliminate the water content in the respective fuel cell blocks B1 through B4. This arrangement efficiently eliminates the water content in the fuel gas conduits and in the oxidizing gas conduits of the unit fuel cells 30 included in each of the fuel cell blocks B1 through B4, thus lowering the water content to the appropriate level. The structure of this embodiment does not require any bypass in the unit fuel cells 30, unlike the structure of cited Patent Document 1. Th characteristic structure of the embodiment uses the frame of the unit fuel cell 30 equivalent to the existing one and does not substantially increase the size of the fuel cell stack 120.

In the specified fuel cell block in the flooding state, the back-pressure control valves in the oxidizing gas exhaust manifold and the fuel gas exhaust manifold are regulated in the opening direction from the reference positions to widen the opening areas. This efficiently eliminates the water content in the oxidizing gas conduits and in the fuel gas conduits of the respective unit fuel cells included in the specified fuel cell block, thus lowering the water content to the appropriate level. In the specified fuel cell block in the dry-up state, on the other hand, the back-pressure control valves in the oxidizing gas exhaust manifold and the fuel gas exhaust manifold are regulated in the closing direction from the reference positions to narrow the opening areas. This desirably causes the humidified gaseous hydrogen and the humidified air to be retained in the oxidizing gas conduits and in the fuel gas conduits of the respective unit fuel cells included in the specified fuel cell block, thus raising the water content to the appropriate level. The reference area of the invention corresponding to the opening area of the oxidizing gas exhaust manifold or the fuel gas exhaust manifold when the corresponding back-pressure control valve is set in its reference position.

The water content tends to increase in the most downward fuel cell block among the fuel cell blocks B1 through B4 constituting the fuel cell stack 120, because of the gravity. The more open positions than the middle positions are set to the reference positions of the back-pressure control valves of the oxidizing gas exhaust manifold and the fuel gas exhaust manifold in the most downward fuel cell block. This accelerates elimination of the water content.

Some examples of possible modification are given below. The arrangement of the second embodiment regulates the back-pressure control valves in the fuel cell block in the flooding state in the opening direction from the reference positions to widen the opening areas and accelerate elimination of the water content. One possible modification of the second embodiment may set the back-pressure control valves in their full-closed position and then fully open the back-pressure control valves to generate pulsation and thereby eliminate the water content, like the control of the first embodiment. The arrangement of the first embodiment generates pulsation to eliminate the water content. One possible modification of the first embodiment may set the middle position between the full-open position to fully open the outlets of the oxidizing gas conduits 36 and the full-closed position to fully close the outlets of the oxidizing gas conduits 36 to the reference position of the tubular switching member 70 and shift the reference position of the tubular switching member 70 to the more open position than the middle position under the condition of flocculation of water droplets, so as to accelerate elimination of the water content.

In the structure of the second embodiment, the back-pressure control valves are located at the outlets of the fuel gas exhaust manifold and the oxidizing gas exhaust manifold in each fuel cell block. The back-pressure control valves may be replaced by the tubular switching member 70 and the stepping motor 79 for actuating the tubular switching member 70, which are included in the structure of the first embodiment. The tubular switching member 70 actuated by the stepping motor 79 regulates the opening area of each gas exhaust manifold, thus attaining the similar effects to those of the second embodiment.

The procedure of the second embodiment determines the settings of the back-pressure control valves to the more open positions than the reference positions, the reference positions, or the more closed positions than the reference positions, according to the range of the internal resistance Ri, Ri<C1, C1≦Ri≦C2, or C2<Ri. More meticulous position control may be adopted according to the requirement. For example, modified control may open the back-pressure control valves to the positions before the full-open positions in a range of C0≦Ri<C1 and to the full-open positions in a range of R<C0, whereas the control of the second embodiment fully opens the back-pressure control valves in the range of Ri<C1.

The structure of the second embodiment regulates both the air back-pressure control valve and the hydrogen back-pressure control valve in the opening direction or in the closing direction, when the fuel cell block falls in the flooding state or in the dry-up state. Similar effects may be obtained by regulating only the air back-pressure control valve in the opening direction or in the closing direction or by regulating only the hydrogen back-pressure control valve in the opening direction or in the closing direction.

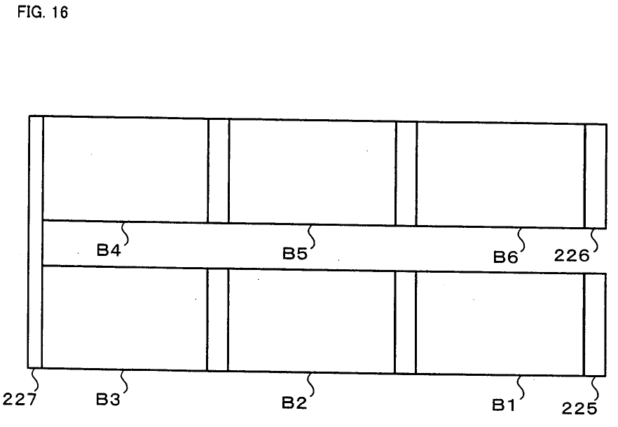

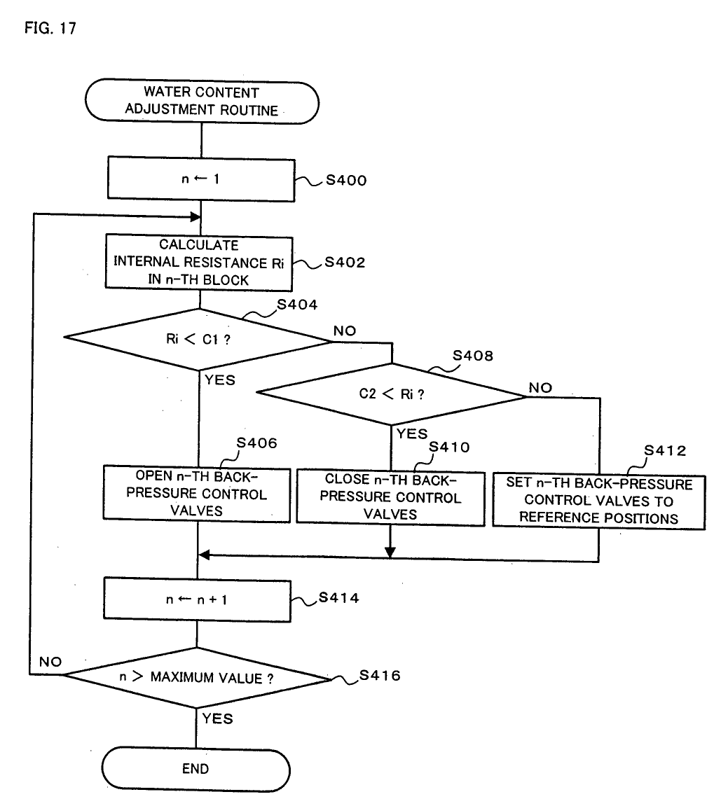

In the structure of the second embodiment, the fuel cell stack 120 has the two lines L1 and L2 and each line is divided into two parts. Namely there are a total of four fuel cell blocks B1 through B4. In another example shown in FIG. 16, each line is divided into three parts, and there are a total of six fuel cell blocks B1 through B6. In this modified structure where each line is divided into three parts, fuel cell blocks 81, B3, B4, and B6 on the respective ends are in contact with either an end plate 225 or 226 or a joint plate 227. Heat release through these end plates 225 and 226 and the joint plate 227 lowers the temperature in these end fuel cell blocks B1, B3, B4, and B6, which thus tend to fall in the flooding state. The center fuel cell block B2 is located between the heat-generating fuel cell blocks B1 and B3, and the center fuel cell block B5 is located between the heat-generating fuel cell blocks B4 and B6. These center fuel cell blocks B2 and B5 thus do not readily release heat but tend to fall in the dry-up state. The respective fuel cell blocks accordingly have different levels of water content. The technique of the invention is significantly effective for such a structure.

The procedure of the second embodiment executes the water content adjustment routine shown in the flowchart of FIG. 14. The procedure may adopt another water content adjustment routine shown in the flowchart of FIG. 17. In this modified routine, the CPU 82 first sets a value ‘1’ to a process counter n (where n represents an integral number) (step S400), calculates an internal resistance Ri of an n-th fuel cell block from inputs of electric current measured by the ammeter AM and voltage measured by an n-th voltmeter VMn (step S402), and determines whether the calculated internal resistance Ri satisfies Ri<C1 (step S404). When Ri<C1 is satisfied, the CPU 82 regulates an n-th air back-pressure control valve AVn and an n-th hydrogen back-pressure control valve HVn from their reference positions in the respective opening directions to increase the flows of the air and hydrogen into the n-th fuel cell block (step S406). When Ri<C1 is not satisfied at step S404, that is, in the case of C1≦Ri, on the other hand, the CPU 82 subsequently determines whether the calculated internal resistance Ri satisfies C2<Ri (step S408). When C2<Ri is satisfied, the CPU 82 regulates the n-th air back-pressure control valve AVn and the n-th hydrogen back-pressure control valve HVn from their reference positions in the respective closing directions to retain the flows of the air and hydrogen in the n-th fuel cell block (step S410). When C2<Ri is not satisfied at step S408, that is, when the calculated internal resistance Ri is in the range of C1≦Ri≦C2, it is determined that the n-th fuel cell block has the appropriate range of the water content. The CPU 82 accordingly sets the n-th back-pressure control valve AVn and the n-th hydrogen back-pressure control valve HVn to the reference positions (step S412). After the processing at any one of steps S406, S410, and S412, the CPU 82 increments the value of the process counter n by one (step S414) and determines whether the incremented value of the process counter n exceeds its maximum value (4 in this embodiment) (step S416). When the value of the process counter n does not exceed the maximum value, the program returns to step S402 and executes the processing of and after step S402. When the value of the process counter n exceeds the maximum value, the program exits from this routine. This modified procedure also calculates the internal resistance Ri in each of the fuel cell blocks B1 through B4 and regulates the back-pressure control valves in the opening direction or in the closing direction, based on the calculated internal resistance Ri, thus attaining the appropriate level of water content in each of the fuel cell blocks B1 through B4.

The structure of the second embodiment uses the multiple voltmeters VM1 through VM4 disposed at multiple voltage measurement points. One scanning-type voltmeter for scanning multiple voltage measurement points may be adopted to simplify the structure of the fuel cell system.

In the embodiment discussed above, the fuel cell system 120 is mounted on the vehicle 10. The fuel cell system 120 may be mounted on any other vehicles and transportation machines like trains and aircraft, and may be incorporated in any cogeneration systems installed for domestic applications and industrial applications. In any case, the fuel cell system 120 and its applications exert the equivalent functions and effects to those discussed above.

The above embodiments are to be considered in all aspects as illustrative and not restrictive. There may be many modifications, changes, and alterations without departing from the scope or spirit of the main characteristics of the present invention. All changes within the meaning and range of equivalency of the claims are therefore intended to be embraced therein.

1. A fuel cell system comprising a fuel cell that generates electric power through electrochemical reaction of oxygen included in an oxidizing gas, which is flown through an oxidizing gas conduit provided on a cathode side, and hydrogen included in a gaseous fuel, which is flown through a fuel gas conduit provided on an anode side, said fuel cell system further comprising:
a switching member that opens and closes an outlet of at least one of the oxidizing gas conduit and the fuel gas conduit; and
an actuation module that actuates said switching member to open and close the outlet of the at least one gas conduit,
wherein the actuation control module controls said switching member first to narrow an opening area of the outlet of the at least one gas conduit to or toward zero and then to widen the opening area of the outlet of the gas conduit thus generating pulsation of the gas conduit.

2. A fuel cell system in accordance with claim 1, said fuel cell system comprising:
a fuel cell stack that is a laminate of a number of fuel cells; and
a gas exhaust manifold that connects with the outlet of the at least one gas conduit included in each of the fuel cells,
wherein said switching member is located in said gas exhaust manifold.

3. A fuel cell system in accordance with claim 1, said fuel cell system comprising:
a fuel cell stack that is a laminate of a number of fuel cells;
an oxidizing gas exhaust manifold that connects with outlets of respective oxidizing gas conduits included in the fuel cells; and
a fuel gas exhaust manifold that connects with outlets of respective fuel gas conduits included in the fuel cells,
wherein said switching member is located in at least one of said oxidizing gas exhaust manifold and said fuel gas exhaust manifold.

4. A fuel cell system in accordance with claim 3, wherein said fuel cell stack is divided into multiple fuel cell blocks, where each of the multiple fuel cell blocks comprises multiple fuel cells,
said oxidizing gas exhaust manifold is provided in each of the multiple fuel cell blocks and connects with outlets of respective oxidizing gas conduits of the multiple fuel cells included in each fuel cell block, and
said fuel gas exhaust manifold is provided in each of the multiple fuel cell blocks and connects with outlets of respective fuel gas conduits of the multiple fuel cells included in each fuel cell block.

5. A fuel cell system in accordance with claim 1, wherein said switching member has a slit,
positioning of a remaining area of said switching member other than the slit to face the outlet of the at least one gas conduit narrows an opening area of the outlet of the gas conduit to or toward zero, and
positioning of the slit of said switching member to face the outlet of the at least one gas conduit widens the opening area of the outlet of the gas conduit.

6. A fuel cell system in accordance with claim 2, wherein said switching member has a slit,
positioning of a remaining area of said switching member other than the slit to face the outlet of the at least one gas conduit narrows an opening area of the outlet of the gas conduit to or toward zero, and
positioning of the slit of said switching member to face the outlet of the at least one gas conduit widens the opening area of the outlet of the gas conduit.

7. A fuel cell system in accordance with claim 6, wherein said switching member is a tubular switching member, which has the slit on a circumferential face thereof and is rotatably located in the gas exhaust manifold.

8. A fuel cell system in accordance with claim 3, wherein said switching member has a slit,
positioning of a remaining area of said switching member other than the slit to face the outlet of the at least one gas conduit narrows an opening area of the outlet of the gas conduit to or toward zero, and
positioning of the slit of said switching member to face the outlet of the at least one gas conduit widens the opening area of the outlet of the gas conduit.

9. A fuel cell system in accordance with claim 8, wherein said switching member is a tubular switching member, which has the slit on a circumferential face thereof and is rotatably located in the gas exhaust manifold.

10. (canceled)

11. A fuel cell system in accordance with claim 10, wherein said actuation control module controls said actuation module to generate the pulsation in the at least one gas conduit according to a state of water flocculation in the gas conduit.

12. A fuel cell system in accordance with claim 10, wherein said actuation control module controls said actuation module to generate the pulsation in the at least one gas conduit, either when an output of the fuel cell exceeds a preset output level or when a measurement of integral power of the fuel cell exceeds a preset power level.

13. A fuel cell system in accordance with claim 10, said fuel cell system comprising:
a storage module that stores an output behavior of the fuel cell under condition of flocculation of water droplets in the at least one gas conduit,
wherein said actuation control module controls said actuation module to generate the pulsation in the gas conduit, when an observed output behavior of the fuel cell in service substantially coincides with the output behavior stored in said storage module.

14. A fuel cell system in accordance with claim 10, wherein said actuation control module controls said actuation module to generate the pulsation in the at least one gas conduit at regular intervals.

15. A fuel cell system comprising a fuel cell that generates electric power through electrochemical reaction of oxygen included in an oxidizing gas, which is flown through an oxidizing gas conduit provided on a cathode side, and hydrogen included in a gaseous fuel, which is flown through a fuel gas conduit provided on an anode side, said fuel cell system comprising:
a fuel cell stack that is a laminate of a number of fuel cells and is divided into multiple fuel cell blocks, where each fuel cell block comprising multiple fuel cells;
oxidizing gas exhaust manifolds, each of which connects with outlets of respective oxidizing gas conduits of the multiple fuel cells included in each fuel cell block;
fuel gas exhaust manifolds, each of which connects with outlets of respective fuel gas conduits of the multiple fuel cells included in each fuel cell block; and
regulation modules, each of which regulates an outlet opening area of at least one of said oxidizing gas exhaust manifold and said fuel gas exhaust manifold in each fuel cell block; and
an actuation module that actuates said regulation modules,
wherein the actuation control module controls said regulation modules to first close an opening area of the outlet opening area of the at least one of said manifolds and then widens the opening area, thus generating pulsation of the gas conduit.

16. A fuel cell system in accordance with claim 15, said fuel cell system further comprising:
a parameter value measurement module that measures value of a parameter relating to a level of water content in each of the fuel cell blocks; and
a water level determination module that determines the level of water content in each of the fuel cell blocks, based on the value of the parameter measured by said parameter value measurement module;
wherein the actuation control module controls said regulation module in a specific fuel cell block, which has an excess level of water content determined by said water level determination module, to increase the outlet opening area of said at least one gas exhaust manifold to be greater than a preset reference area.

17. A fuel cell system in accordance with claim 16, wherein said parameter value measurement module measures an internal resistance in each of the fuel cell blocks, and
said water level determination module determines that a specific fuel cell block has an excess level of water content, when the observed internal resistance of the specific fuel cell block is below a preset appropriate range.

18. A fuel cell system in accordance with claim 15, said fuel cell system further comprising:
a parameter value measurement module that measures value of a parameter relating to a level of water content in each of the fuel cell blocks;
a water level determination module that determines the level of water content in each of the fuel cell blocks, based on the value of the parameter measured by said parameter value measurement module; and
the actuation control module controls said regulation module in a specific fuel cell block, which has an insufficient level of water content determined by said water level determination module, to decrease the outlet opening area of said at least one gas exhaust manifold to be smaller than a preset reference area.

19. A fuel cell system in accordance with claim 18, wherein said parameter value measurement module measures an internal resistance in each of the fuel cell blocks, and
said water level determination module determines that a specific fuel cell block has an insufficient level of water content, when the observed internal resistance of the specific fuel cell block is over a preset appropriate range.

20. A fuel cell system in accordance with claim 16, said fuel cell system further comprising:
a block position recognition module that recognizes a positional relation of the multiple fuel cell blocks,
wherein said actuation control module increases the preset reference area of said at least one gas exhaust manifold in a specific fuel cell block, which is recognized to be located downward by said block position recognition module.

21. A fuel cell system in accordance with claim 18, said fuel cell system further comprising:
a block position recognition module that recognizes a positional relation of the multiple fuel cell blocks,
wherein said actuation control module increases the preset reference area of said at least one gas exhaust manifold in a specific fuel cell block, which is recognized to be located downward by said block position recognition module.

22. A vehicle with a fuel cell system in accordance with claim 1 mounted thereon.

23. A vehicle with a fuel cell system in accordance with claim 15 mounted thereon.

24. A fuel cell system according to claim 1, wherein
the actuation control module controls said switching member first to narrow an opening area of the outlet of the at least one gas conduit so as to heighten the inner pressure, and then to widens the opening area of the outlet of the gas conduit, thus generating pulsation in the gas conduit.

25. A fuel cell system according to claim 1, wherein
the actuation control module controls said switching member first to completely close an opening area of the outlet of the at least one gas conduit and then to widen the opening area of the outlet of the gas conduit, thus generating pulsation in the gas conduit.
